(19) United States
(12) Patent Application Publication
(10) Pub. No.: US 2024/0201376 A1
(43) Pub. Date: Jun. 20, 2024

(54) PROCESSING TECHNIQUES FOR LIDAR RECEIVER USING SPATIAL LIGHT MODULATORS

(71) Applicant: Texas Instruments Incorporated, Dallas, TX (US)

(72) Inventors: Terry A. Bartlett, Dallas, TX (US); Nirmal C. Warke, Saratoga, CA (US); David P. Magee, Allen, TX (US); Jeffrey Scott Farris, Flower Mound, TX (US); Patrick Oden, McKinney, TX (US)

(21) Appl. No.: 18/589,693

(22) Filed: Feb. 28, 2024

Related U.S. Application Data
(62) Division of application No. 15/619,048, filed on Jun. 9, 2017, now abandoned.
(60) Provisional application No. 62/348,002, filed on Jun. 9, 2016.
(60) Provisional application No. 62/353,291, filed on Jun. 22, 2016.

(51) Int. Cl. G01S 17/26; G01S 7/481; G01S 7/484

(52) U.S. Cl. CPC G01S 17/26; G01S 7/4814; G01S 7/4816; G01S 7/4817; G01S 7/484

(57) ABSTRACT

In described examples, a method includes receiving light from a field of view on a spatial light modulator that includes a two-dimensional array of picture elements in rows and columns; and determining a portion of the two-dimensional array that corresponds to a region of interest in response to a transmit scan beam illuminating the field of view. The method also includes directing light from the portion of the two-dimensional array to a photodiode, and directing light outside the portion away from the photodiode.

### CROSS-REFERENCE TO RELATED APPLICATIONS

This application claims the benefit of U.S. application Ser. No. 15/619,048 filed Jun. 9, 2017, which also claims priority under 35 U.S.C. § 119(e) to U.S. Provisional Patent Application Ser. No. 62/348,002, filed Jun. 9, 2016, entitled “Method to Improve Receive SNR in 3D Distance Measurement Systems Using Micromirror Arrays,” naming Terry Bartlett et. al. as inventors and U.S. Provisional Patent Application Ser. No. 62/353,291, filed Jun. 22, 2016, entitled “Processing Techniques for LIDAR Receiver using DMD,” which Applications are hereby incorporated herein by reference in their entireties.

### TECHNICAL FIELD

This relates generally to light detection and ranging (LIDAR) systems, and more particularly to LIDAR systems using spatial light modulators (SLMs).

### BACKGROUND

LIDAR systems measure depth in response to beams of light that are reflected from objects in a field of view (FOV). The depth measurements can form a three-dimensional map of the FOV. In LIDAR systems, a transmitter directs scan beams or pulses of light towards the FOV. In some scanned beam systems, the transmitter directs the scan beam from a laser or near infrared (NIR) laser light source.

If a system's receiver has an array of photodiodes to collect all light from the FOV, then the reflected light (from the scan beam) is subject to noise from additional reflected light that impacts the scene. For example, at the receiver, the received light includes sunlight reflected from objects and reflections of light other light sources in addition to the scan beam. To improve the received signal, a receiver includes mirrors or other mechanical and electrical systems to movably track the reflected light from the transmitted scan beam, which can reduce the noise from the scene observed by the receiver.

In one example, a focused near infrared (near-IR) laser beam scans a scene of interest, and objects in the FOV are located, ranged and tracked in response to a delay time of reflected light energy. In response to the measurements, a depth map is generated to create a three-dimensional (3D) image of the scene. A laser pulse or other energy waveform scans locations in the FOV. A receiver receives reflections from objects in the FOV and, in response to time of flight calculations, assigns an estimated range to the object at that location. The reflected pulse is detectable by a detector or an array of detectors sensitive to the transmitted beam. However, the received signal includes noise from sunlight or other background radiation, which increases a difficulty of detecting the reflected pulse. If the receiver has a narrow field of view optical system that attempts to track the scanned laser beam (for viewing only radiation reflected from the scanned laser beam's direction), then noise can be reduced. In that approach, the receiver scans the FOV in synchronization with the scanning laser beam, but that approach can require large, bulky and expensive mechanical mirrors and rotors. An alternative approach has an array of detectors, but that approach can have prohibitive cost and inferior performance.

### SUMMARY

In described examples, a method includes receiving light from a field of view on a spatial light modulator that includes a two-dimensional array of picture elements in rows and columns; and determining a portion of the two-dimensional array that corresponds to a region of interest in response to a transmit scan beam illuminating the field of view. The method also includes directing light from the portion of the two-dimensional array to a photodiode, and directing light outside the portion away from the photodiode.

### BRIEF DESCRIPTION OF THE DRAWINGS

FIG. 1 is a block diagram of a LIDAR system in operation.

FIG. 2 is a block diagram of a LIDAR system in an autonomous vehicle application.

FIG. 3 is a block diagram of an example LIDAR system in operation.

FIG. 4 is a block diagram for another example LIDAR system.

FIG. 5 is a block diagram for an alternative example LIDAR system.

FIGS. 6A and 6B are diagrams of operations of a single micromirror and of a corresponding pupil lens.

FIGS. 7A and 7B are block diagrams of operations of two different types of micromirrors.

FIG. 8 is a block diagram for another example LIDAR system.

FIG. 9 is a block diagram of an example LIDAR system architecture.

FIG. 10 is a block diagram showing further details of an example LIDAR system.

FIG. 11 is another block diagram showing further details of an alternative example LIDAR system.

FIG. 12 is a block diagram of another embodiment LIDAR system in operation.

FIG. 13 is a diagram of a movable window in a LIDAR receiver.

FIG. 14 is a close-up diagram of the movable window of FIG. 13.

FIG. 15 is a diagram of an example receiver operation for sampling reflections due to a moving transmission spot beam.

FIG. 16 is a diagram of additional details of the receiver operation of FIG. 15.

FIG. 17 is a diagram of further details of the receiver operation of FIG. 15.

FIG. 18 is a diagram of more details of the receiver operation of FIG. 15.

FIG. 19 is a diagram of a compressive sensing operation of an example LIDAR receiver.

FIG. 20 is a diagram of a compressive sensing operation of another example LIDAR receiver.

FIG. 21 is a flow diagram of operation for a LIDAR receiver.

FIG. 22 is a flow diagram of alternative operation for a LIDAR receiver.

FIG. 23 is a flow diagram of another operation for a LIDAR receiver.

FIG. 24 is a flow diagram of yet another operation for a LIDAR receiver.

FIG. 25 is a flow diagram of a compressive sampling operation for a LIDAR receiver.

### DETAILED DESCRIPTION

In the drawings, corresponding numerals and symbols generally refer to corresponding parts, unless otherwise indicated. The drawings are not necessarily drawn to scale. In this description, the term “coupled” can include connections made with intervening elements, and additional elements and various connections can exist between any elements that are “coupled.”

Example embodiments incorporate at least one SLM in a LIDAR receiver. In some example LIDAR receivers, the SLMs are digital micromirror devices (DMDs). A DMD is a two-dimensional array of addressable picture elements, each picture element is a micromirror. By directing one or more of the micromirrors in the DMD that correspond to energy reflected from an object in a region of interest (ROI) in a FOV to reflect the received light to a detector, while other micromirrors in the DMD that receive energy from the FOV are positioned to direct received light away from the detector, the signal to noise ratio (SNR) of the receiver can be greatly increased. The SNR increases because the detector only receives light reflected from the ROI due to illumination by the scan beam. The detector only receives light reflected by objects in the FOV illuminated by the scan beam, while light reflected from other sources is directed away from the detector. In at least some examples, a receiver using multiple detectors receives reflections due to multiple scan beams by using different portions of the SLM. The SLM directs reflected light associated with the individual scan beams to one of the multiple detectors. In another arrangement, optics further focus and collimate the reflected light to the detector. In further arrangements, optics focus and collimate the reflected light from the objects in the FOV onto the reflective elements in the SLM.

In another example, the transmitter modulates or encodes scan beams so that a single detector can receive and discriminate reflected energy due to multiple scan beams simultaneously. The modulated scan beams can later be distinguished from one another by demodulation or filtering in the receiver. Also, in some examples, use of a SLM (such as a DMD) with an individual row (or column) addressing capability performs higher speed receiver operation by providing a fast update of the SLM patterns used to receive and to direct the reflected scan beams. In further examples, subsampling techniques using the spatial light modulator further increase the resolution of the receiver. Subsampling of a transmission beam spot directs a selected subportion of reflected light to a detector, then moving the selected portion to another position to repeatedly subsample the transmit beam spot. In another example, resolution of the receiver increases independently of the resolution of the transmitted scan beam. In certain examples, the receiver can compensate for jitter or tolerances in the transmitted scan beam.

In further examples, compression sensing techniques further enhance the performance of the receiver using the spatial light modulator (such as a DMD). In compressive sensing, compression patterns display as random matrices on the SLM picture elements that receive the reflected energy. Compressive sensing allows recovery of the reflected signal with less than a complete scan of the reflected beam further improving the speed of the system and enhancing overall performance. By subsampling the scan beam, processing speed is enhanced. Using the row addressing capability of an SLM in certain examples, a receiver pattern can display on the spatial light modulator a two-dimensional window region that scans the portion of the field of view corresponding to a moving scan beam. The receiver scan pattern can correspond to a transmitter scan beam pattern to increase the reception of reflected light from objects in the FOV that are scanned by a pattern from a beam transmitter. Accordingly, the receiver pattern can track the motion of the transmitted scan beam. Using a row addressable SLM, the two-dimensional window region can rapidly update by changing the trailing row and leading row pattern for the two-dimensional window region on the SLM, while the remainder of the SLM pattern is unchanged.

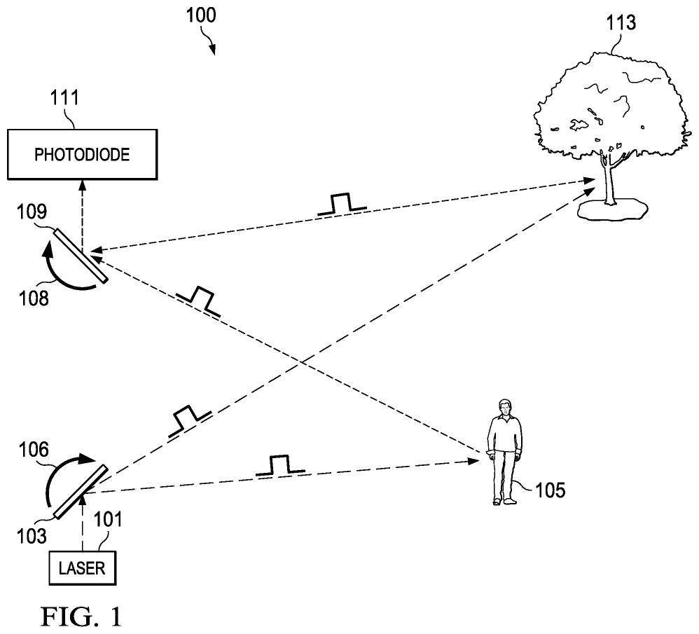

FIG. 1 is a block diagram of a LIDAR system in operation. In FIG. 1, system 100 includes a laser (or other light source) 101 arranged to illuminate a mirror 103. In an example, a near infrared (NIR) laser beam is used. A rotating mount 106 rotates mirror 103 so that a laser beam movably travels across a FOV and scans the FOV. In FIG. 1, a human FIG. 105 is in one part of the FOV, and a tree 113 is in another part of the FOV. The tree 113 and the human FIG. 105 are located at different distances from mirror 103 in the LIDAR transmitter.

When a pulse of laser energy enters the FOV from the surface of mirror 103, reflective pulses appear when the laser light illuminates an object in the FOV. These reflective pulses arrive at mirror 109 that can also movably rotate on a rotating mount 108. The reflective pulses reflect into a photodiode 111. The photodiode 111 can be any of a number of photodiode types, including: avalanche photodiodes (APDs); silicon photomultipliers (SiPMs), which can include arrays of APDs; PIN photodiodes, photocells; and/or other photodiode devices. Imaging sensors such as charge-coupled devices (CCDs) can be the photodiodes. In at least one example, the sensor is an array of photodiodes or photocells.

As shown in FIG. 1, the photodiode 111 receives reflective light pulses. Using the speed of light, the travel time for the pulses that are sent from laser 101 and received onto mirror 103 can be determined. A time-of-flight computation can determine the distance of objects from the photodiode. A depth map can plot the distance information. In an example, a 3D image displays the depth map in a visual representation. In other arrangements, the depth map data is useful for guidance or navigation.

In FIG. 1, the photodiode 111 receives light from the scan beam reflected by the objects in the FOV. However, in FIG. 1 the photodiode 111 also receives light reflected from objects in the FOV due to sunlight falling into the scene or from other light sources, which represents noise to the photodiode in the LIDAR receiver. Rotating mirrors in the receiver to track the scan beam such as 109 can improve the performance by increasing the amount of reflected scan beam light received relative to the overall light signal (improving the signal to noise ratio (SNR)), but these rotating mirrors require motors, mechanical rotors, and corresponding power consumption. Mechanical rotors can introduce mechanical error and jitter, and can require maintenance such as alignment. The laser 101 can include a mechanical mirror 106 as shown in FIG. 1. However, in alternative arrangements, an analog MEMS mirror and light source can replace the laser 101 and rotating mirror 103. In another arrangement, a DMD and light source can replace the laser 101 and rotating mirror 103.

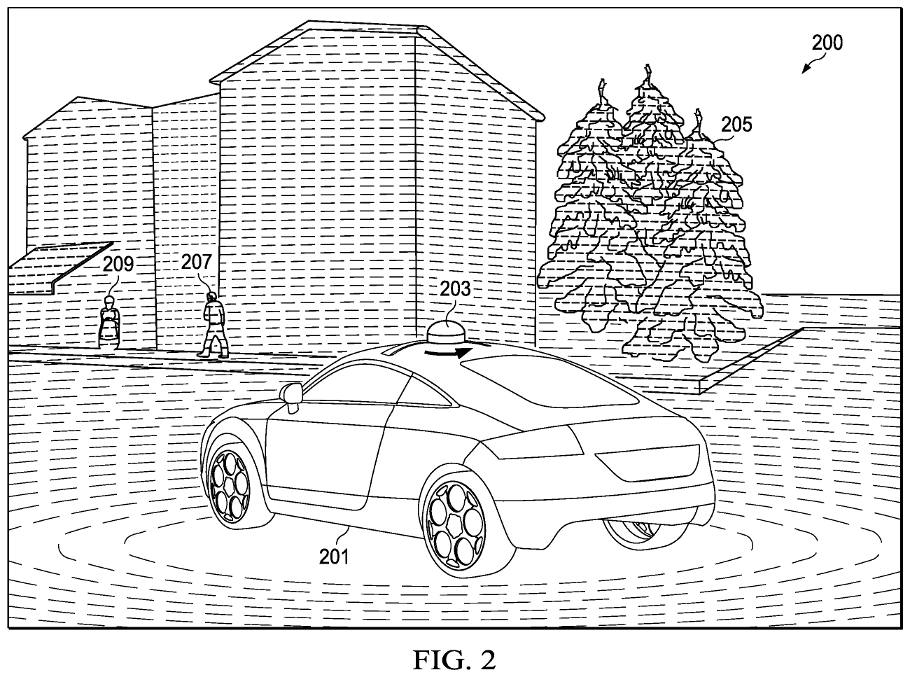

FIG. 2 shows an example vehicle mounted LIDAR system 200, such as in autonomous vehicle applications. In FIG. 2, a car 201 includes a mechanically rotating LIDAR system 203 mounted on the rooftop of the vehicle. The rotating LIDAR system transmits laser pulses and measures received reflections from objects around the system using time-of-flight calculations based on the speed of light. LIDAR systems for autonomous vehicles are available from Velodyne Lidar, Inc. An example system has sixty-four lasers arranged with corresponding detectors mounted in a rotating housing with a rotator motor that rotates the housing at up to 20 Hz. This system requires power for the motor, the many lasers and the many detectors, and requires substantial physical space on the roof of the vehicle.

Further the rotating systems such as in FIG. 2 have limitations including poor vertical resolution, fixed angular pitch, fixed vertical pitch, multi-dimensional calibration, power consumption, cost, size and reliability and such systems require maintenance due to many moving parts. These vehicular LIDAR systems are restricted to collecting a fixed number of vertical points at a given angular pitch per revolution, limiting the rate at which distance measurements are gathered from a desired region in a FOV.

In example embodiments, distance measurements at an arbitrary point in the FOV occur at any given time. To provide arbitrary beam positioning, any of the following can be used: a motorized laser positioning system with two-dimensional (2D) motion; a laser directed onto a 2D analog mirror (laser with mechanical mirror positioning); a laser directed at an analog MEMS solid state device, and a laser directed onto a reflective SLM such as a DMD to provide solid state 2D scan beam positioning. The examples include receivers that can operate with any laser beam used for scanning in the transmitter. Further arrangements use other light sources. In at least one example, the transmitter transmits near infrared (NIR) light.

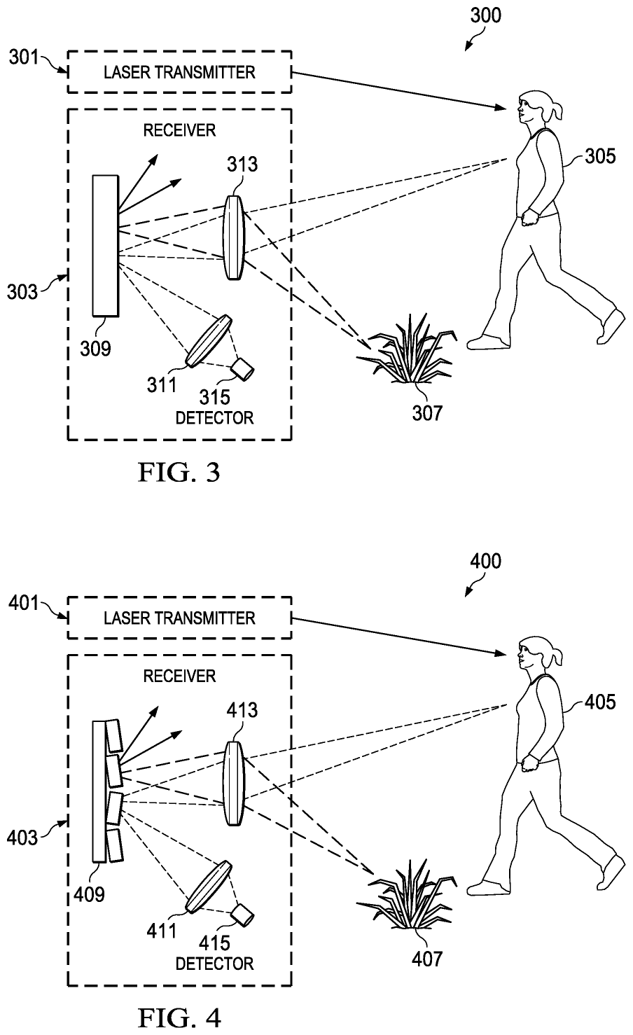

FIG. 3 depicts an example LIDAR system 300 including a LIDAR receiver 303 using a spatial light modulator 309. An example spatial light modulator is a digital micromirror device (DMD). In alternative arrangements, a liquid crystal on silicon (LCoS) device, or by a phase spatial light modulator (PSLM) is the SLM. In FIG. 3, laser transmitter 301 transmits a laser beam to the FOV. In the FOV, laser beams illuminate a human 305. Receiver 303 receives light energy that reflects from the FOV.

In an example, the SLM 309 can be implemented using a DMD that includes an array of micromirrors arranged in a two-dimensional array. Each of the micromirrors in the DMD can take one of two active positions, an ON position that directs reflected energy to lens 311 and detector 315; and an OFF position that directs the light elsewhere. FIG. 3 shows this operation. Detector 315 can be any detector that is sensitive to the energy from the transmitter, including photodiodes such as an avalanche photodiode (APD). In these arrangements, a single detector or sometimes a few detectors are used. Because only a single or a few detectors are used, high quality photodiodes (such as APDs) are useful without adding substantial cost. The DMD 309 also reflects light from the FOV away from the detector 315. In the example in FIG. 3 light reflected from the plant 307 reflects away from detector 315. A focusing optical element 313 directs the reflected light from the FOV onto the DMD 309. Another optical element directs reflected light to detector 315. In other examples, the optical elements use more elements. Some arrangements omit the optical elements 311, 313.

In alternative examples, the SLM 309 can be a liquid crystal on silicon (LCoS) device. In another arrangement, the SLM 309 can be a phase SLM (PSLM). A PSLM shifts the phase of light impacting the surface of the SLM, and can receive light as a wavefront and by performing a phase shift, can direct the reflected light as a wavefront in selected directions. These arrangements direct received light corresponding to a scan beam from a LIDAR transmitter to a detector, while received light from other sources can be directed away from the detector.

FIG. 4 is a block diagram of another example for a LIDAR system 400. In FIG. 4, the reference labels for elements similar to those in FIG. 3 are similar, for clarity. In FIG. 4, laser transmitter 401 outputs a beam that can scan the field of view. In FIG. 4, the field of view again includes a human 405, and a plant 407. In the example shown in FIG. 4, the laser transmitter outputs a scan beam that illuminates the human 405. However, light from sources other than the scan beam illuminates the plant 407. A receiver 403 includes a spatial light modulator, which, in this example, is DMD 409. A first optical element 413 focuses the light reflected by objects in the FOV onto the array of micromirrors in DMD 409. In the example shown in FIG. 4, some of the mirrors in the array of mirrors of DMD 409 are in a first tilt position so that the light reflected from the human 405, which the scan beam from transmitter 401 illuminates, reflects to lens 411 and onto a detector 415. However, as shown in FIG. 4, light reflected from objects in the field of view that is due to solar energy into the scene or reflected light from objects in the field of view that corresponds to light from other sources which impacts the DMD 409 reflects away from the detector 415. By reducing the light from sources other than the scan beam received at the detector 415, the signal to noise ratio (SNR) for the received light substantially increases. The increase in SNR is at low cost and uses solid-state components without the need for motors, or mechanical rotors. Although only four micromirrors are in FIG. 4, a DMD can include thousands or even millions of addressable micromirrors that can be individually positioned. Integrated circuits including DMDs are commercially available from Texas Instruments Incorporated.

Because the individual mirrors in the array of mirrors in the DMD can be selectively addressed and positioned, those mirrors in the DMD that are receiving reflected light due to the scan beams from the FOV can be directed to reflect the energy to the detector 415, while those mirrors in the array of mirrors in the DMD that are not receiving the reflected scan beam light can reflect the energy (light from the FOV that does not result from the scan beam) away from the detector 415, rejecting the noise due to sunlight or other light falling into the FOV.

In the example of FIG. 4, the detector 415 produces an output proportional to the received light power. If the received light power is proportional to the entire irradiated area in the FOV, the SNR (referenced to the mean background light level when using the received light from only a region of interest (ROI)) can be expressed by EQ. (1):

$${SNR}_{ROI} = ( \frac{{M}_{FOV}}{{M}_{ROI}} ) * {SNR}_{FOV} \qquad ( 1 )$$

where: M_{FOV}=the number of pixels (for an example using a DMD, number of mirrors) used for the entire FOV; and M_{ROI}=the number of pixels (for an example using a DMD, number of mirrors) used for the ROI.

Because the background photon shot noise is proportional to the square root of the light intensity, the SNR (for an arrangement such as in FIG. 4 referenced to the background induced root mean square (rms) noise) can be expressed by EQ. (2):

$${SNR}_{ROI \_ n} = \sqrt{\frac{{M}_{FOV}}{{M}_{ROI}}} * {SNR}_{FOV \_ n} \qquad ( 2 )$$

According to EQ. (1) and EQ. (2), if all of the micromirrors are the same size (as for a DMD device), and if only a few hundred of the total number of micromirrors are used for the ROI, with the remaining thousands or hundreds of thousands of mirrors used for the rest of the FOV, then the SNR improvement attained by use of these arrangements can be several orders of magnitude. For example, an XGA compatible DMD device has 1024×768 micromirrors, or 768,432 total micromirrors. Larger and smaller DMD arrays are commercially available.

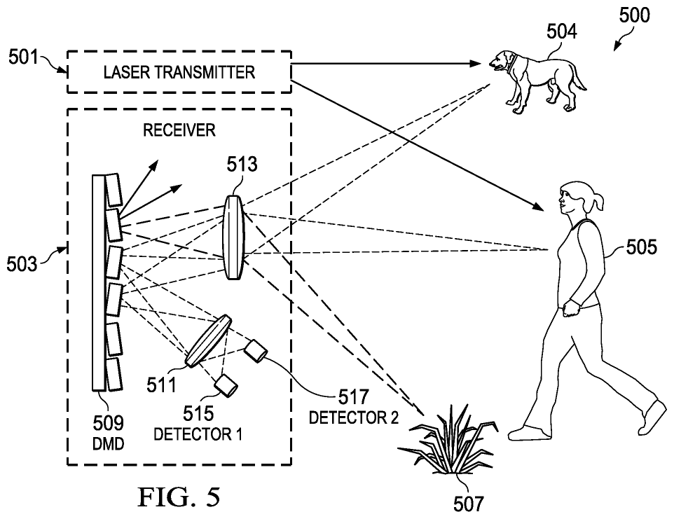

FIG. 5 is a block diagram of a further example of a LIDAR system 500. For elements in FIG. 5 that are similar to those in FIG. 3, the elements in FIG. 5 have similar reference labels, for clarity. Transmitter 501 outputs multiple scan beams onto objects in a FOV. In the example of FIG. 5, two scan beams scan different portions of the FOV. A LIDAR receiver 503 receives light reflected from objects in the FOV. An optical focusing element 513 focuses the received light on to the spatial light modulator 509, which is a DMD device in the example of FIG. 5. An optical element 511 focuses light reflected by certain picture elements in the spatial light modulator on detectors 515 (Detector 1) and 517 (Detector 2).

In the operation shown in FIG. 5, the laser transmitter 501 outputs two scan beams towards a FOV. In further examples, systems can have more than two scan beams. In FIG. 5, the objects shown in the FOV include a dog 504, a human 505, and a plant 507. In the operation shown in FIG. 5, a first scan beam illuminates the dog 504, and a second scan beam illuminates the human 505. Neither of the scan beams illuminates the plant 507, but the plant 507 is illuminated by solar energy or other light that falls onto the FOV.

In FIG. 5, the SLM 509, a DMD, has patterns loaded into it that position certain pixels, here shown as micromirrors in the DMD, to reflect light received as reflected light from objects in the FOV illuminated by the laser scan beams to two detectors, Detector 1 (515) and Detector 2 (517). The picture elements (in this example, the micromirrors of DMD 509) are selected to correspond to the scan beams. As the scan beams move across the FOV, micromirrors in the DMD selectively turn to reflect the light from the objects illuminated by the scan beams to a detector. By assigning regions in the FOV to the detectors 515 and 517 and using the pattern displayed on the SLM (DMD 509 in the example), the light reflected by objects in the field of view from one scan beam can be directed to one of the detectors 515 or 517. Light reflected by objects in the field of view due to illumination by the other scan beam reflects to the other detector 515 or 517. By providing a dedicated detector 515, 517 for each scan beam, the LIDAR receiver can simultaneously receive the reflections due to the two scan beams, thereby increasing the FOV scanning speed and the overall performance of the LIDAR system 500.

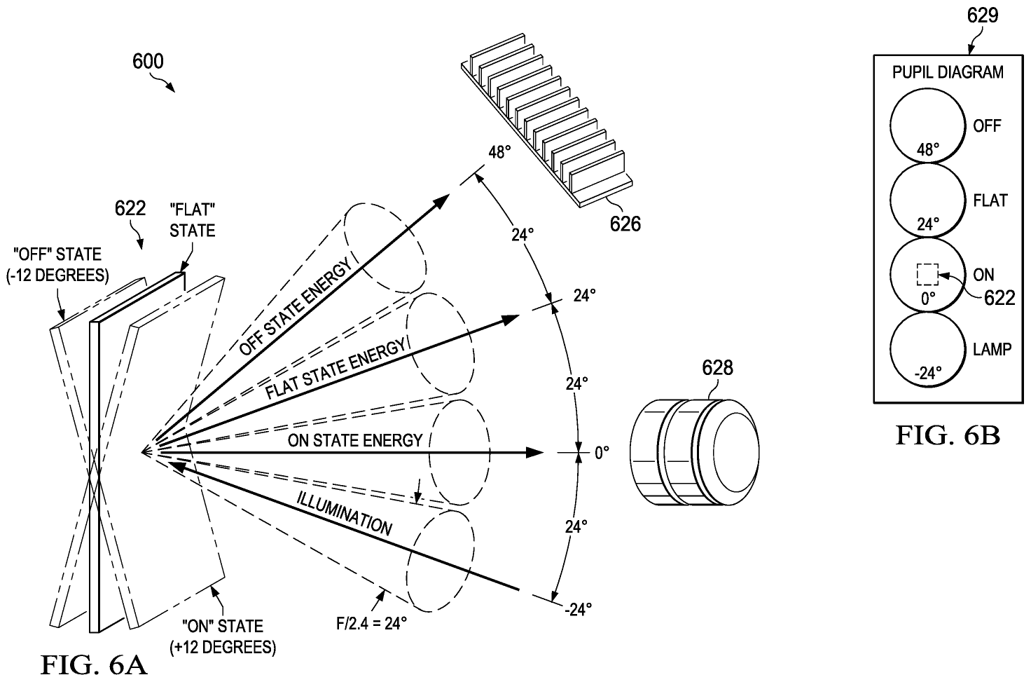

FIGS. 6A and 6B show the operation of a single micromirror 600 of a DMD device and a corresponding pupil diagram for the DMD, respectively. A DMD device is a micro-electromechanical system (MEMS) device featuring thousands, hundreds of thousands or more miniature mirrors fabricated in a single packaged device using semiconductor processing technologies. In an example, the micromirrors are coated with aluminum. In further examples, the micromirrors are coated with gold or other reflective surface material. The micromirrors are disposed on electromechanical hinges that selectively move under an electric potential. The micromirrors are arranged in a two-dimensional array in rows and columns. Also, the array of micromirrors can be loaded with a display pattern, and while the micromirrors display that pattern, an addressable memory location associated with each micromirror can be loaded with the next pattern to display by the DMD. While some DMDs are arranged so that the entire array pattern must be completely rewritten to change the DMD mirror positions, recent DMD devices increasingly include row addressable capability, so that a single row (or column) can be modified in the storage array, and the DMD array can then be reset to move only the mirrors in a single row, while the rest of the DMD display pattern remains unchanged. Row addressability provides a fast pattern update capability. In some examples, this feature increases receiver scan speed as is further described hereinbelow. Future DMD devices may include single micromirror addressing or random micromirror addressing, which are features of additional examples.

For operation of a micromirror, FIGS. 6A and 6B show the tilt angles of a single micromirror of a DMD device, and a corresponding pupil diagram, respectively. In FIG. 6A a DMD micromirror 622 has +/−12 degree tilt from a starting position. DMD devices can include micromirrors with other tilt angles, such as +/−17 degrees or +/−10 degrees. When no power is provided to the DMD mirror array, the mirrors all take the same position, which is labeled the “flat state” position in FIG. 6A. In the flat state, the micromirror 622 is vertical when the device is oriented as shown in FIG. 6A. The micromirror 622 has two additional positions used in an active operation, which are the “ON” state position and the “OFF” state position. As shown in FIG. 6A, when the micromirror 622 is in the ON state, it is tilted about an axis about +12 degrees from the FLAT position. When the micromirror 622 is in the OFF state, it tilts about −12 degrees from the FLAT state position. In FIG. 6A, the ray diagram shows the direction of light in the system for the various micromirror positions. In the ray diagram, the ray labeled “illumination” enters the DMD device and strikes the face of the micromirror 622. In these examples, the light reflects from objects in a field of view. In a DMD video projection system, such as in a video display, the illumination could come from a laser or color wheel. The ray labeled “ON STATE ENERGY” reflects from the micromirror 622 when it is in the ON position. In this example, the micromirror 622 is arranged for the illumination ray to enter the system at an angle of 24 degrees below the horizontal (−24 degrees). When the micromirror 622 is in the FLAT state, the reflected light will leave the micromirror 622 at a corresponding angle of reflection of 24 degrees above the horizontal, as shown by the ray labeled FLAT STATE ENERGY in FIG. 6A. When the micromirror 622 is in the ON state, and tilts +12 degrees, the illumination ray strikes the micromirror and the reflected light, shown by the ray labeled ON STATE ENERGY in FIG. 6A, leaves the micromirror at an angle of zero degrees. Optics 628 can collect this light and focus it on a detector (not shown) as described hereinabove. When the micromirror 622 is in the OFF STATE shown in FIG. 6A, the micromirror is tilted −12 degrees from the vertical, and in this position the light reflects away from the optics 628 as shown by the ray labeled OFF STATE ENERGY in FIG. 6A. The light can reflect to a light dump such as 626 in FIG. 6, or in other arrangements, the light can simply disperse.

FIG. 6B is a pupil diagram corresponding to the tilt angles of the micromirror. At the bottom of FIG. 6B, a pupil labeled LAMP represents the incoming light reflected from the field of view to the DMD. The pupil position labeled “ON” shows the light ray leaving the micromirror when it is in the ON position (micromirror 622 is shown in dashes in FIG. 6B, representing an ON state position.) The pupil labeled FLAT in FIG. 6B shows the light ray leaving the micromirror when it is in the FLAT position (this position is not used in the operation of these arrangements, as all of the micromirrors take the FLAT position at the same time when the DMD is unpowered). The pupil labeled OFF in FIG. 6B shows the direction the reflected light takes when the mirror is tilted −12 degrees, in the OFF position.

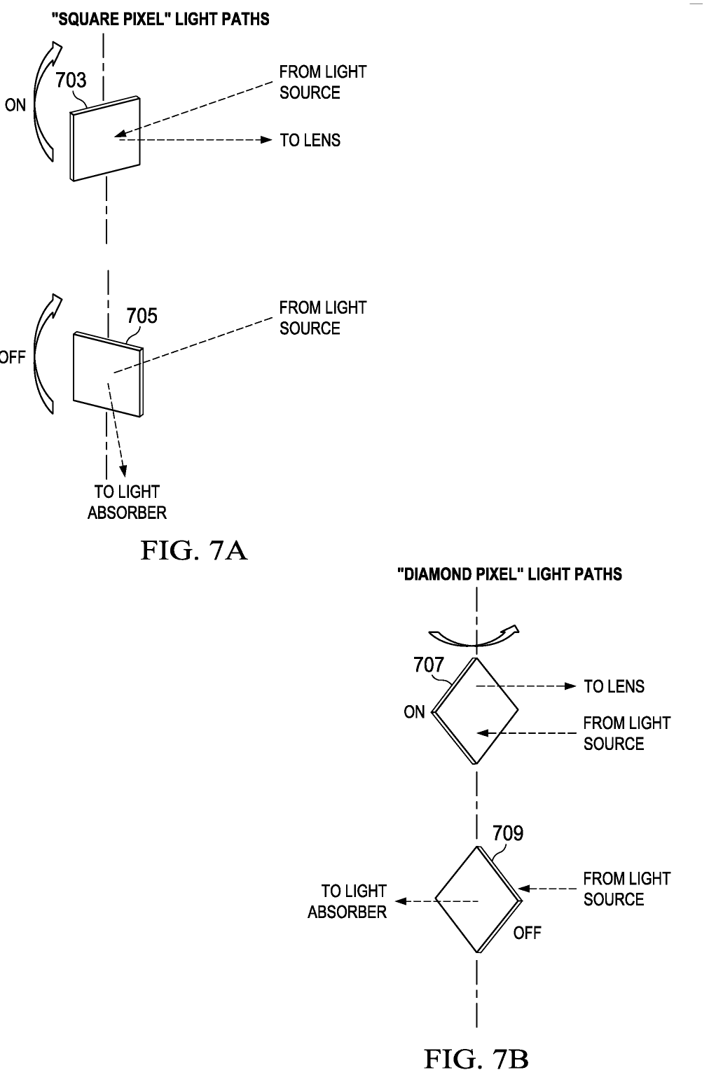

FIGS. 7A and 7B show the operations of two different orientations for DMD micromirrors compatible with these arrangements. In DMD devices, micromirrors can be oriented in a “Manhattan” or square orientation with respect to one another, as shown in FIG. 7A. In FIG. 7B, the individual micromirrors (e.g., which form picture elements or “pixels” in DMD projector systems) are arranged in a diamond pixel arrangement. The tilt angles lie along different axes for the different DMD types. For the square pixel arrangement in FIG. 7A, the micromirrors tilt about a horizontal axis. Micromirror 703 is in the ON state position, where the angled light from a scene or light source impacts the mirror and reflects to the right to optics for collecting the reflected light. In FIG. 7A, the micromirror 705 is shown in the OFF state and in this state, the light from the scene that impacts the micromirror 705 reflects away from the lens and to a light absorber (or light dump).

Similarly, the diamond pixel arrangement for the micromirrors shown in FIG. 7B has an ON and OFF state. Micromirror 707 is positioned in the ON state. Light that impacts the micromirror 707 reflects to the right to a lens or other optics to collect the light. Micromirror 709 is positioned in the OFF state for the diamond pixel arrangement DMD. In FIG. 7B, the micromirror 709 reflects light from the scene or a light source away from the lens and to a light absorber to the left.

Another type of DMD has a “tilt and roll pixel” (TRP) micromirror. The TRP micromirror has a complex motion so that in the ON state, the reflected light may be reflected on a horizontal plane, such as to the right or left, while in the OFF state, the mirror may reflect light vertically, such as up or down with respect to the array, so that the light absorber may be above or below the array, while the lens can be left or right of the mirror array. TRP DMDs have reduced spacing between micromirrors and so have increased density per unit area. TRP DMDs are compatible with these arrangements.

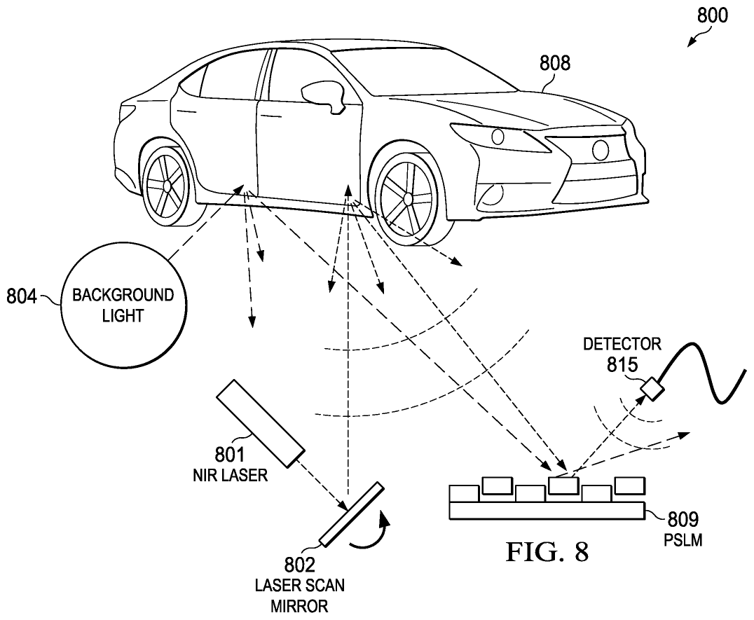

FIG. 8 is a block diagram of a LIDAR receiver system 800 incorporating a phase spatial light modulator (PSLM) 809. In FIG. 8, an illumination source is a near infra-red (NIR) laser 801. A scanning apparatus 802, here shown as a rotating mirror, enables the system to scan the FOV with a laser beam. In the example shown in FIG. 8, the scan beam from the scanning apparatus 802 is shown striking a portion of a vehicle 808 that is within the FOV. Another portion of the vehicle 808 is illuminated by background light 804, such as sunlight, that is in the scene.

In the LIDAR receiver of FIG. 8, PSLM 809 directs a portion of the light reflected from the FOV to detector 815. In at least one example, similar to the DMD used as SLMs described hereinabove, a PSLM in a LIDAR receiver can direct reflected laser light from a FOV to a detector, while also reducing the amount of background light that reaches the detector.

An example PSLM device has an array of addressable cells, with each cell imparting a different optical phase delay, depending on the electrical signal applied to each cell. A PSLM device can be a liquid crystal device (LC), a liquid crystal on silicon device (LCOS), or a microelectromechanical system (MEMS) device. A MEMS PSLM usually has an array of small mirrors that displace a distance in a direction normal to the array plane in response to an electrical signal. An array of memory cells associated with the mirrors can store patterns for display.

The function of a PSLM is to change the shape of the optical wavefront that is incident on the device. The PSLM can impart a linear phase delay on a wavefront which has the effect of steering the beam in a different direction. A PSLM can also impart a curved wavefront which can focus the wavefront in a fashion similar to a lens. The primary advantage of a PSLM is that it can be quickly reconfigured to steer or focus a beam to a desired direction or focus the beam to a desired plane.

An example MEMS PSLM includes an array of micromirrors that move in and out from the base of the PSLM in a direction normal to the face of the PSLM. Accordingly, instead of tilting as in the DMD devices, in the MEMS PSLM, micromirrors are translated in position. By providing a phase shift to an incoming wavefront of light received from the FOV, the PSLM can direct a portion of the light from a region of interest (ROI) as an outgoing wavefront to the detector 815, while the light that strikes the PSLM that is reflected from the FOV due to background illumination is directed away from the detector. By making the ROI correspond to the reflections from the scanned beam from the laser scan mirror 802, the receiver can have increased signal to noise ratio performance with respect to the background light.

If a LIDAR receiver uses a PSLM, then light from the FOV can fall onto the PSLM without the aid of an imaging optic. Particular areas or points of interest within the scene can be selected by imposing a spatial wavefront pattern on the PSLM such that the light received from a region of interest is steered towards the detector. As a consequence, the received light not in the region of interest is directed to an area away from the detector. In this manner, the PSLM can perform a similar function to the imaging DMD in directing laser light toward the detector while directing background light away from the detector.

By reflecting the light received from a region of interest (ROI) to the detector 815, while directing the light received from other regions of the FOV, the arrangement of FIG. 8 increases the signal to noise ratio (SNR) as described hereinabove.

Also, because the PSLM can direct light impacting the array of micromirrors, the PSLM in a LIDAR transmitter can also illuminate the scene. A linear phase function displayed on the PSLM directs the laser light in a desired direction. The phase front is altered for each beam direction causing the beam to scan in a particular pattern required to obtain range or reflectivity image of the scene.

In a similar manner a different linear phase function displayed on the PSLM will direct the light in a different direction toward the detector. Furthermore, by displaying a curved phase function on the PSLM the beam focuses at the detector. The focus on the detector occurs without the need for an optics element, reducing the cost of the system and reducing the number of components. An advantage of a PSLM is that a controller can quickly reconfigure the PSLM to steer or focus a beam to a desired direction or focus to a desired plane. In some arrangements having a PSLM as the SLM, fewer optical elements can be used as the PSLM provides both focus and steering of the scan beam.

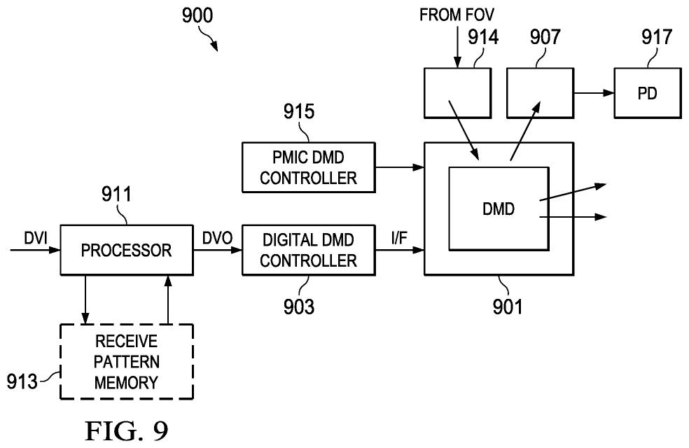

FIG. 9 is a block diagram of a LIDAR receiver 900 using an SLM. In this example, the SLM is a DMD. In FIG. 9, a processor 911 is coupled to a receive pattern memory 913. Patterns in the receive pattern memory can be loaded to the DMD 901 to control the portions of the DMD 901 that are directed to reflect light to a detector, and to direct other light away from the detector as described hereinabove. The memory can be non-volatile memory or volatile memory. RAM (e.g. DRAMs, SRAM) and FLASH are all useful memory types. Receive Pattern Memory 913 can be implemented using commercial memory devices, or can be embedded within a processor integrated circuit as indicated by the dashed lines around 913. The processor 911 can be a digital signal processor (DSP). The processor 911 can also be implemented using a micro-controller unit (MCU), mixed signal processor (MSP), an analog signal processor, a microprocessor unit (MPU), a reduced instruction set computer (RISC) or a RISC core, an Advanced RISC Machine (ARM) core, or other programmable processor device. The processor can be implemented as a user definable logic device such as a field programmable gate array (FPGA) or a complex logic programmable device (CPLD) or can be implemented as part of an application specific integrated circuit (ASIC). The processor can receive digital video input (DVI) from an external source that forms patterns displayed on the DMD 901. A power management IC (PMIC) DMD controller 915 supplies high voltages to the DMD provides analog output signals for controlling other elements. The Digital DMD Controller 903 provides the digital data, clocking and reset signals to the DMD 901 to enable loading patterns for display on the DMD, and control of the updating of the pattern displaying on the DMD 901. Optics 914 provides a focus function to direct light from a FOV onto the DMD, while optics 907 provide focus of light reflected from the DMD 901 to a photodiode 917. DMD 901 reflects light to the photodiode 917 and away from the photodiode 917, as described hereinabove.

Example integrated circuits that can implement the system 900 shown in FIG. 9 include: DMD controller ICs available from Texas Instruments Incorporated, such as the DLPC3430 DMD controller; and the Texas Instruments DLPC2601 ASIC device that provides both digital and analog controller functions. Analog DMD controller devices that can implement circuit 915 include the DLPA2000 device available from Texas Instruments Incorporated. Any one of a number of DMD devices available from Texas Instruments Incorporated can implement the DMD 901. In further alternative arrangements, other commercially available SLMs are useful, such as liquid crystal on silicon (LCOS) devices.

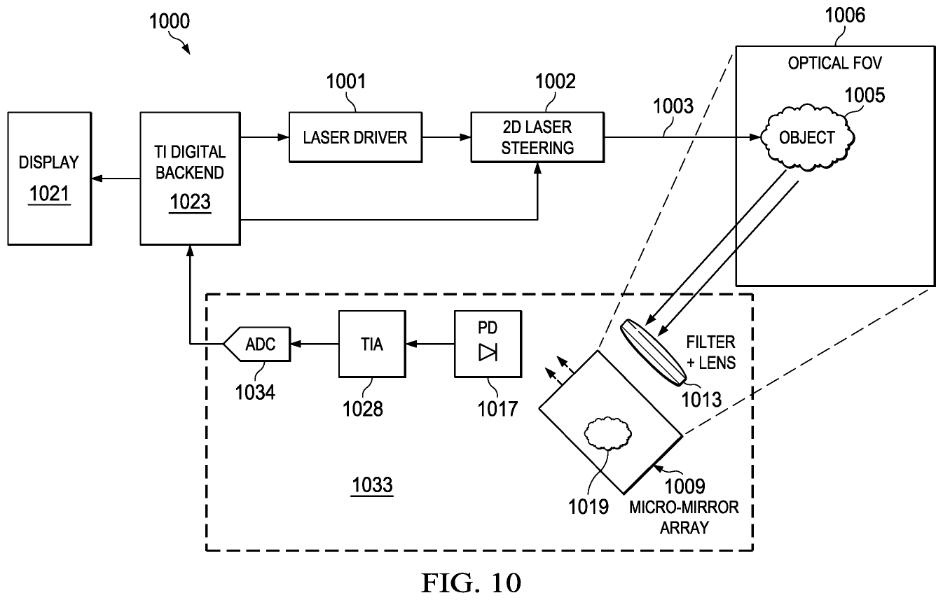

FIG. 10 is a block diagram for a LIDAR system 1000. In FIG. 10, a laser driver 1001 supplies illumination to a two-dimensional laser steering device 1002, such as a rotating mirror, analog MEMS mirror, or SLM, as described hereinabove. A scan beam 1003 scans the FOV 1006. In the example of FIG. 10, the FOV includes an object 1005 that reflects light from the scan beam 1003.

In FIG. 10, light reflects from the object 1005 and to a receiver 1003 including optics 1013, and a spatial light modulator 1009, here shown as a DMD. Light reflects from object 1005 onto a portion 1019 of the array of micromirrors in the DMD 1009. The DMD 1009 directs a portion of the reflected light to the photodiode PD 1017. Using the micromirrors in the DMD 1009, the reflected light corresponding to the scan beam impacting the object 1005 in region 1019 reflects to the photodiode 1017, while the mirrors in the micromirror array that are impacted by light from the FOV that does not correspond to the scan beam are positioned to direct the light away from the photodiode 1017. As described hereinabove, the signal to noise ratio (SNR) increases by rejecting background noise from the signal the DMD directs to the photodiode 1017.

The output of the photodiode 1017 couples to a transconductance amplifier TIA 1028, which outputs an amplified analog signal that corresponds to the light received at the photodiode 1017; analog to digital converter ADC 1034 samples the TIA output and converts the analog signal to a digital signal such as a digital weight. The output of the ADC 1034 couples to a digital backend 1023 that includes processing to perform time of flight calculations and to form a depth map from depth measurements of the scene as described hereinabove. A display 1021 can display a 3D image of the depth map in a two-dimensional display for viewing. The control signals needed to output laser pulses from laser driver 1001 and to steer the beam using the two-dimensional steering element 1002 couple to output from the digital backend 1023. The digital backend 1023 can include the functions or integrated circuits such as the processor, the digital DMD controller and/or the PMIC DMD controller shown in the example of FIG. 9.

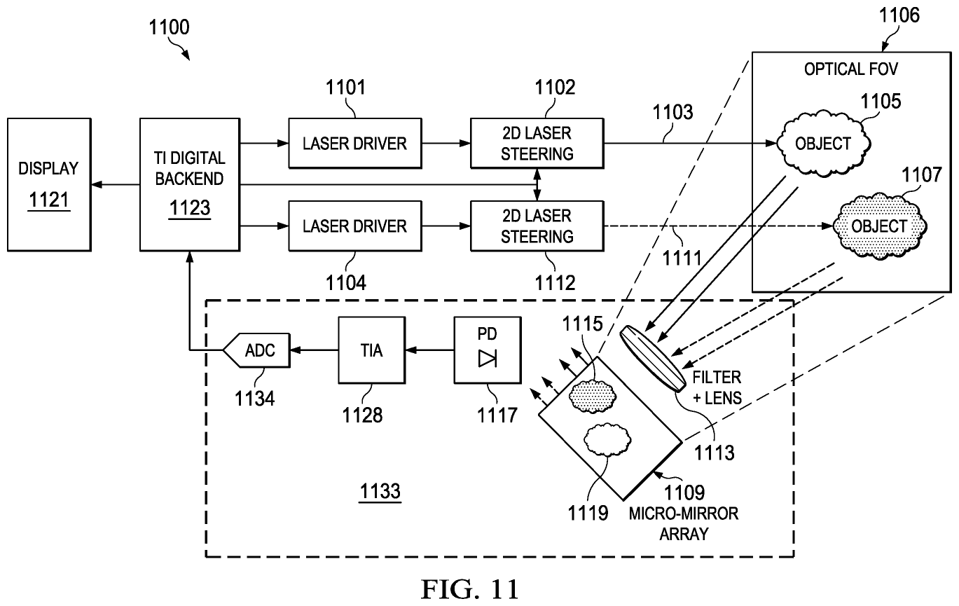

FIG. 11 is a block diagram of another arrangement for a LIDAR system 1100. In FIG. 11, elements similar to those in FIG. 10 have similar reference labels. For example, laser driver 1101 corresponds to laser driver 1001 in FIG. 10. Laser driver 1101, the two-dimensional laser scanning 1102, the digital backend device 1123, and the display driver 1121 correspond to the elements 1001, 1002, 1023, 1021 in FIG. 10 as described hereinabove. The laser driver 1101 and two-dimensional laser steering element 1102 transmit a scan beam 1103 to the FOV 1106. Also, in FIG. 11, a second laser driver 1104 and the two-dimensional laser steering element 1112 transmit a second scan beam 1111 to FOV 1106. In the example of FIG. 11, separate scan beams 1103 and 1111 illuminate two objects 1105, 1107, respectively.

In the example of FIG. 11, scan beams 1103 and 1111 illuminate two objects 1105, 1107 in the FOV and the optical element 1113 receives reflected light in a receiver 1103. A spatial light modulator, here shown as a DMD device 1109, receives reflected light corresponding to each of the scan beams in two different portions of the DMD device 1109.

By displaying appropriate patterns on the DMD, the reflected light corresponding to the scan beams 1103, 1111 that enter the optics 1113 are reflected to and received at photodiode 1117, while light received from other portions of the FOV 1106 that does not correspond to the scan beams is directed away from the photodiode 1117. In the arrangement of FIG. 11, the two scan beams 1103, 1111 are transmitted simultaneously, and the reflected energy is received simultaneously. The received light results in a signal from the photodiode 1117 to the transimpedance amplifier TIA 1128. The TIA 1128 outputs an analog signal corresponding to the received light to the analog to digital converter ADC 1134. The ADC outputs a digital signal that is a weight corresponding to the output of the photodiode 1117. The digital backend 1123 then processes the digital signals. When both scan beams 1103, 1111 are operated simultaneously, the digital backend 1123 provides a differentiation in the transmit beams to enable the received reflected energy to be distinguished by the receiver processing. In one example, different modulation schemes are used with laser pulses in the scan beams so that the receiver and digital backend 1123 can discriminate between the pulses in the received signal. In another arrangement, encoding of the laser pulses can provide a coding scheme to enable the receiver and digital backend 1123 to discriminate between reflected signals corresponding to each of the scan beams.

The arrangement of FIG. 11 uses two scan beams with a single photodiode PD 1117. An alternative arrangement can use two photodiodes such as shown in FIG. 5. In this alternative arrangement, the two photodiodes with the processing elements of FIG. 11 form a LIDAR receiver that can receive reflections from two scan beams simultaneously, without the need for modulation or encoding. In this approach, the DMD 1109 displays patterns arranged to direct reflected light from the FOV corresponding to one scan beam to one photodiode, while the DMD pattern directs reflected light corresponding to another scan beam to a second photodiode.

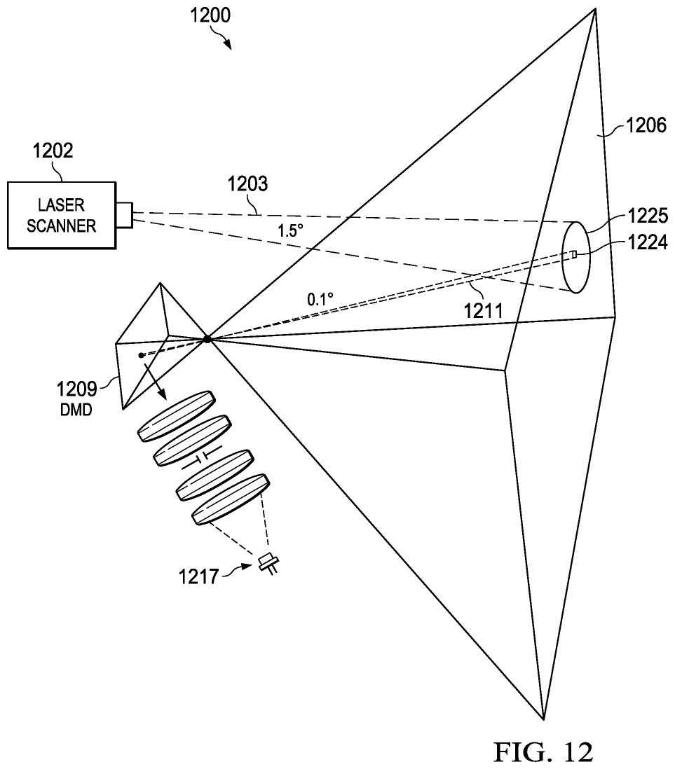

FIG. 12 is a block diagram of another example LIDAR system 1200. FIG. 12 shows transmit beam spot subsampling. In FIG. 12, a laser scanner 1202 provides a scan beam 1203. In this example, the scan beam 1203 has a radius of 1.5 degrees. The position of the scan beam 1203 can include some error due to jitter, mechanical wear of components in laser scanner 1202 such as motors and rotors, and alignment of components. The transmit scan beam 1203 is shown performing a scan of FOV 1206. The beam 1203 illuminates an area 1225 in the FOV 1206.

In operation, a receiver includes a spatial light modulator, here shown as DMD 1209. The portion of the DMD positioned to reflect light to the photodiode 1217 is less than the portion of the DMD that corresponds to the scan beam 1225 at the field of view 1206. By subsampling the transmit beam spot 1225 and only receiving light from area 1224 corresponding, in this example, to a single picture element in DMD 1209, the receive beam is much narrower than the transmit beam, here the reflected beam 1211 is shown with a radius of 0.1 degrees. The receiver resolution is therefore higher than an independent from the transmitter resolution. Position errors and jitter in the transmit beam can be compensated for using the subsampling operation of the receiver, that is, the receiver directs reflected energy from a smaller portion of the transmit beam spot 1225 than the spot the scan beam makes in the field of view 1206. By moving the mirrors in the DMD 1209 to select different portions of the spot, the receiver can subsample the area illuminated by the transmit beam spot, making the receiver resolution independent from the transmit resolution.

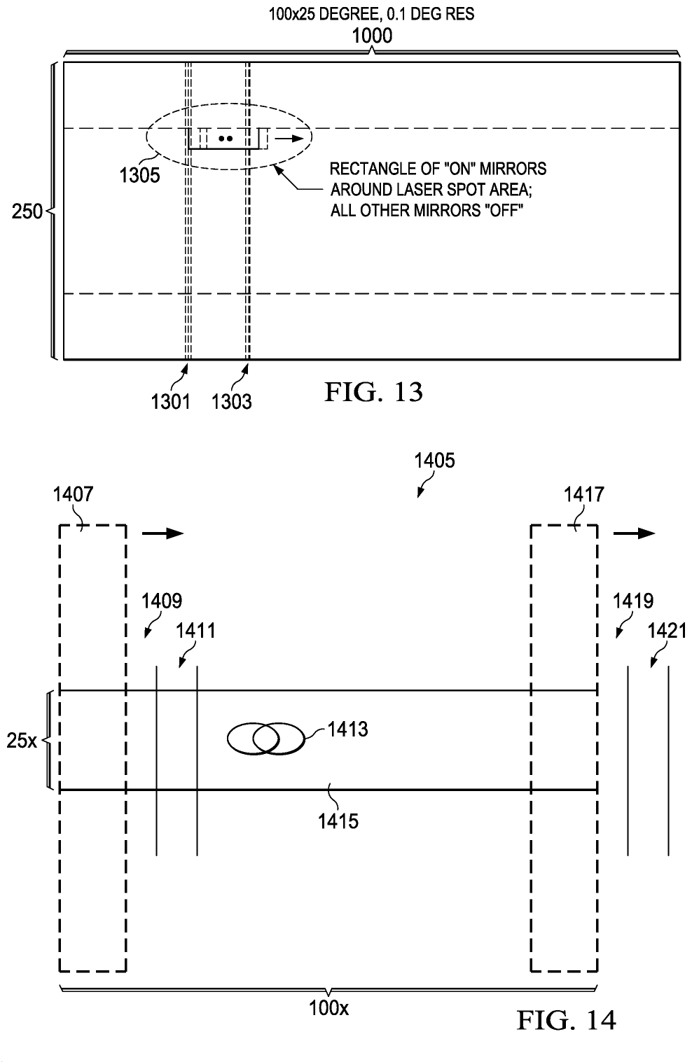

While the subsampling shown in FIG. 12 can be performed by displaying a new pattern at the DMD for each DMD sample, loading the entire DMD array and resetting the pixels for each subsample takes a time determined by the loading speed of the DMD memory cells. For example, because a DMD array can have 250,000 or more picture elements, loading the entire DMD array takes a substantial time. FIG. 13 shows an operation that is useful to increase the scanning speed of the receivers in these arrangements.

In FIG. 13, a DMD 1300 has row address capability. In an alternative arrangement, the DMD address capability can be column address capability. DMDs with row and column address capability are available from Texas Instruments Incorporated. Controllers providing the necessary address signals are also available. In these DMD devices, a row (of column) of pixels can update without the need to write new information to the entire DMD array. Instead, a single row can be addressed and data written for only that row, then that row of pixels can be updated using the DMD “reset” function. By greatly reducing the number of DMD pixels that are written for each scan pattern, the scan speed in the receiver is greatly increased.

FIG. 13 shows an operation for moving a receive window to sample a spot in the field of view corresponding to a scan beam. In FIG. 13, an example array has 250 column and 1000 rows, or 250,000 micromirrors. A two-dimensional window of micromirrors corresponding to the position of the scan beam in the field of view is formed. In the example shown in FIG. 13, the two-dimensional window is a rectangle with 25 mirrors in column dimension, and 100 mirrors in the row dimension. This example configuration provides a resolution of 0.1 degrees.

The rectangular window shown in region 1305 includes the portion of the DMD that receives reflections due to the transmission spot beam, the covered portion is shown as spots inside the region 1305. The window can move along the array from left to right, such as by changing the position of the leading edge row and the trailing edge row of pixels. The leading edge is row 1303 in FIG. 13, and the trailing edge row is row 1301. By writing to the next row ahead of the current position of the rectangular window, the leading edge+1 row, to turn the mirrors in columns in the window for that next row ON, and by writing to the trailing edge row from the current scan operation to turn the mirrors in the window for that current trailing edge row OFF, the position of the rectangular window 1305 can be advanced by one row position, by updating only two rows in the one thousand row array. The number of rows in each step can be varied and can be one, or more rows. In one example, the step size is 10-12 rows.

The fast moving window operation shown in FIG. 13 can support a fast scanning operation for the receiver. When compared to a full array update of the DMD, the time needed to update the step rows is much less than a full load. In a 12 row step example, 12*2/1000 rows are written for each move of the rectangular window. In an example, an update of one row of the DMD array takes approximately 65 nanoseconds. The time to reset the DMD from a prior display to the current display is approximately 8 microseconds. The reset time therefore dominates the update operations. In an example hereinabove, the window is moved in a one row step; but the step size is 10-12 rows in another example. Two portions of the window have to move for each step, the leading edge and the trailing edge. The number of rows to be written is therefore: rows_written=number of shift rows multiplied by two (both leading edge and trailing edge are updated).

In an example using a 10-12 row step size, a rectangle update rate is greater than 100 kHz. Using this example update rate, and using a 1M pixel transmit laser pulse rate, a rectangular window on the receiver SLM of greater than 10 scan pixels wide (wide enough to include the entire transmit beam spot for 10 beam pulses) can move every 10th laser pulse and reliably track the transmit scan beam spots in the FOV. Other rates and window widths are useful to form alternative examples.

FIG. 14 is a closer view of a rectangular window such as shown in FIG. 13. Window 1415 is formed on an SLM with an array of row addressable elements. In an example, the SLM is a DMD. In the example of FIG. 14, the rectangular window has 25 columns, and 100 rows as described hereinabove. In alternative arrangements, the number of columns and rows can vary. In the orientation of FIG. 14, the rows are oriented extending from top to bottom of the figure, and the columns are oriented extending from left to right. The array of elements in the rectangular window 1415 are turned ON to reflect the received light corresponding to a scan beam directed into a FOV to a photodiode (not shown). The remaining elements in the array outside of the window 1415 are turned OFF. In this example, the picture elements of the SLM outside of the window 1415 are turned OFF to reflect light from the FOV that is received but which does not correspond to the scan beam away from the photodiode (not shown). The rows that must change to move the window 1415 from left to right as shown in FIG. 14 are the leading edge row, 1417, and the trailing edge row 1407. The positions 1409, 1411 show the next two trailing row positions the window 1415 will use. The positions 1419, 1421 show the next two leading row positions the window 1415 will use as it moves from left to right.

In operation, the window 1415 can move to track a scan beam directed to a FOV. The window 1415 can move from left to right by changing the trailing row, such as 1407 in FIG. 14, and the leading row such as 1417 in FIG. 14, to shift the position of the window 1415 one row.

In FIG. 14, the current trailing row is 1407. In the next cycle, elements that are in row 1407 that are currently ON will be turned from ON to OFF to move the trailing row to position 1409. Similarly, the current leading row in FIG. 14 is row 1417. In the next cycle, the elements in the window 1415 that are part of the row 1417 will be left in the current position, which is ON. The elements in the row 1419 that will intersect with the columns in window 1415 will be turned from OFF to ON to move the leading edge row of window 1415 to position 1419.

When the SLM is a two-dimensional DMD that is row addressable, the operations needed to move the window 1415 one row to the right as shown in the example of FIG. 14 are to write the elements in the current trailing row 1407 to turn the active picture elements from ON to OFF, and to write picture elements in the next leading row in position 1419 that will intersect the columns in window 1415 from OFF to ON. Moving the window one row requires writing only two rows out the one thousand rows in the SLM in this example, an operation that is much faster than an operation to write the entire array of elements in the SLM. In further examples, other types of row addressable SLMs including LCoS and PSLM form the SLM instead of the DMD. In still further example, a column addressable DMD is useful and the rectangular window can move using column addressing, instead of row addressing.

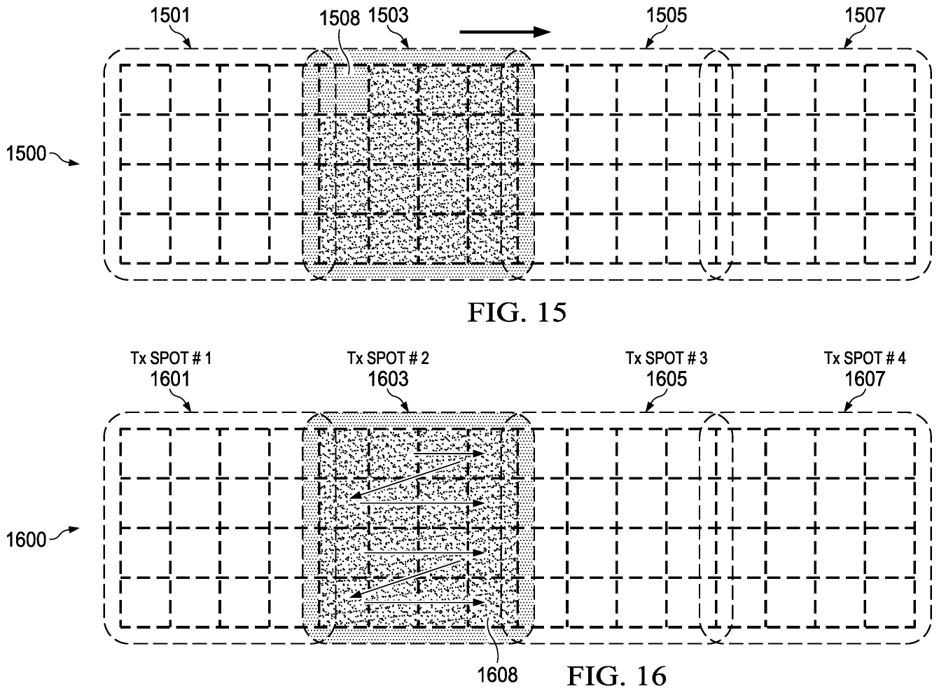

In other examples, the SLM can subsample the transmit beam area. As described hereinabove, the use of subsampling can increase the resolution in the receiver independent of the resolution of the transmit beam. FIG. 15 shows the sampling of the transmit beam by the SLM. In the diagram 1500, the transmit beam moves from left to right and is shown in four positions or spots. To an extent that an SLM's picture elements receive reflected energy that corresponds to a then-current position of the scan beam, those picture elements are mapped onto the scan beam as a 4×4 grid having sixteen elements. In FIG. 15, the positions of the scan beam are 1501, 1503, 1505 and 1507. The current position is the second position in this example sequence, 1503. In the scan beam shown at position 1503, a single picture element 1508 is ON and sampling the scan beam. Accordingly, the SLM is arranged so that the picture element at position 1508 is turned to reflect that received energy to a photodiode (not shown). The remaining picture elements in the four by four array are turned OFF at this time, so that only the single picture element at location 1508 is sampling the reflected energy corresponding to the scan beam at position 1503.

In these arrangements, because the SLM is an addressable device, various patterns can sample the scan beam spot. Also, as described hereinabove, a row addressable SLM can scan the area including the reflected light due to the scan beam very quickly because the DMD pattern can quickly update. FIG. 16 shows a raster scan operation for sampling the reflected energy corresponding to a scan beam position in the FOV. FIG. 16 shows the scanning operation of the SLM for the scan beam position in transmission beam spot #2, 1603. FIG. 16 shows a raster scan pattern useful for subsampling the scan beam. In FIG. 16, the additional transmission beam spots 1601, 1605 and 1607 show the first, third and fourth positions for the transmission scan in a transmit scan beam pattern for scanning the FOV. In the example of FIG. 16, the receiver is scanning current transmission beam spot number 2. In FIG. 16, the current picture element that is ON, labeled 1608, is sampling the last position in a raster scan operation after previously subsampling the beam spot number 2 in sixteen steps. In alternative arrangements, pattern other than the raster scan are used. In these arrangements, use of the SLMs allows a variety of patterns for subsampling the transmission beam spots.

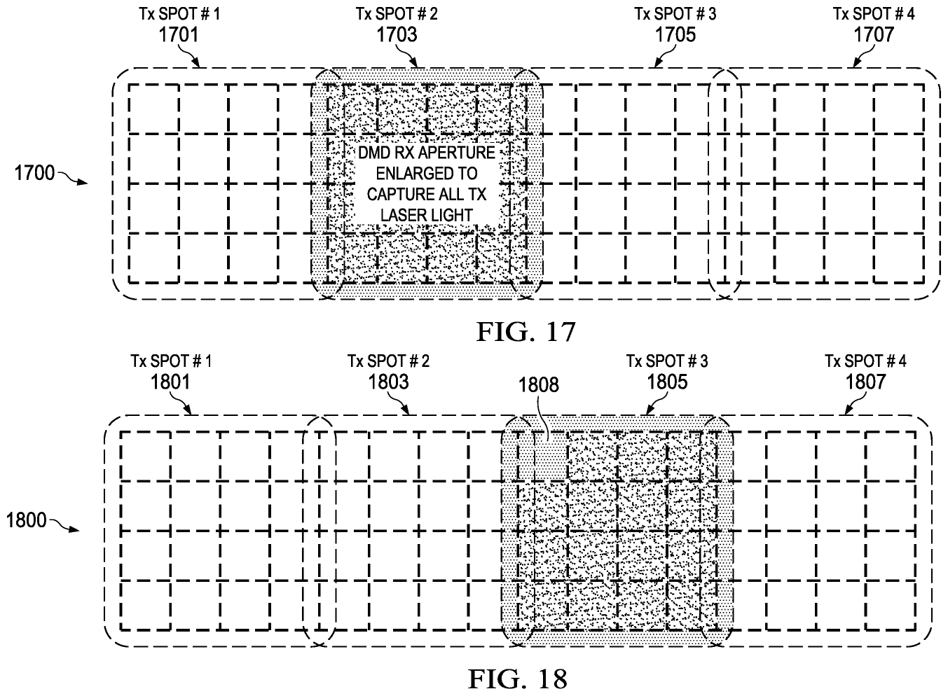

FIG. 17 is another diagram 1700 of the operation to complete sampling of the transmission beam spot. The example of FIG. 17 follows the raster scan operation of FIG. 16. In FIG. 17, the entire SLM array (e.g., a DMD) is concurrently sampled to capture the reflection from the FOV that corresponds to the entire laser beam in the transmission spot. In FIG. 17, this is shown as the second transmission spot 1703. By collecting all of the reflected light for the entire spot in one sample, the processor can normalize the individual samples to the background reflection. If no object reflects from the field of view in a particular laser beam spot, then the final sample provides a background level for the transmission spot. The other positions in the sequence for the transmission beam are shown as 1701, 1705, and 1707 that correspond to transmission beam spot number one, transmission spot number three, and transmission spot number four in FIG. 17.

FIG. 18 is a diagram 1800 of the next sample in the sequence. The transmission beam now moves to transmission spot number three, shown as 1805, and the first sample taken using the SLM for the new transmission spot position is 1808. The raster scan or other scan pattern for subsampling the reflected light corresponding to the transmission spot number three is performed to complete the subsampling operation, and then the complete transmission spot sample such as shown in FIG. 18 is again performed. The transmission beam then moves to transmission spot number four, shown as 1807 in FIG. 18, and the subsampling operation continues.

At least some example embodiments use compressive sensing techniques, because the addressable array of elements in the SLMs in the example receiver embodiments can display arbitrary patterns. Compressive sensing provides algorithms for recovering a sampled signal without individually sampling all the received portions of the signal. Compressive sensing is generally described in the paper “Compressive sampling”, J. Candes, Proceedings of the International Congress of Mathematicians, vol. 3, Madrid Spain, 2006, pp. 1433-1452, which is hereby incorporated by reference herein in its entirety. Compressive sensing provides that for sparse data cases, the entire data signal can be recovered using far less than the total number of individual samples. When applied to example embodiments, compressive sensing provides a fast method of sampling the reflections corresponding to a transmission beam position. Using random matrix patterns displayed only on the portion of the spatial light modulator that corresponds to the transmission beam spot in a compressive sensing algorithm, the transmission beam spot can be subsampled using matrices that have random patterns in a sequence that provides a high probability of correct recovery of the complete information. The use of the compressive sensing technique greatly reduces the number of sampling operations needed and therefore further increases the speed of the sampling operation. While use of compressive sensing for an entire SLM array would be computationally prohibitive as the number of computations rises exponentially with the number of matrix entries, the use of the smaller number of matrix samples in these arrangements, where only the area corresponding to the transmission beam spot is sampled, allows for efficient use of the compressive sensing techniques. The sampling matrices will be small as the matrices are limited to the number of pixel elements needed to cover the transmitted beam spot, and thus the computations needed to process the compressive samples will be relatively small in number.

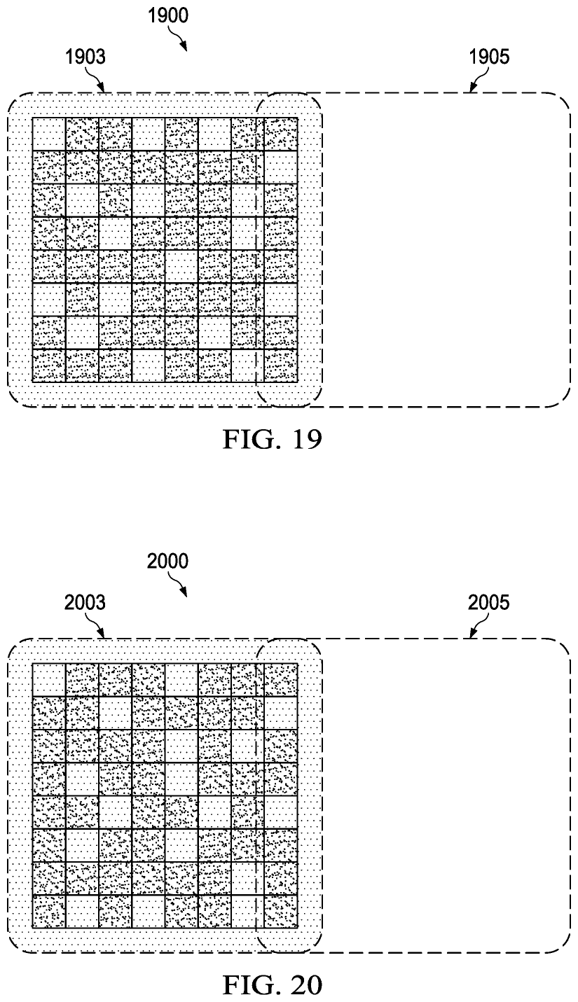

FIGS. 19 and 20 show the operation using compressive sensing for two example random matrices. In FIG. 19, the transmission beam spot is in a position 1903, which is the second transmission beam spot in a scan sequence. In FIG. 19, the SLM, such as a DMD, displays a first random pattern where some of the micromirrors direct reflected light corresponding to the transmission beam spot illuminating an object in the FOV to a photodiode (not shown). The transmission beam spot will move to the next beam spot position, shown as 1905, after the compressive sampling of the beam using the SLM is complete.

FIG. 20 shows a second random matrix pattern displayed on the SLM to sample the transmission beam spot in position 2003, which corresponds to position 1903 in FIG. 19. In FIG. 20, the random pattern displayed on the SLM differs from the random pattern shown on the SLM in FIG. 19. Again, selected mirrors on the DMD in the region corresponding to reflected energy due to the illumination of objects in the FOV by the transmission beam. The compressive sampling sequence continues as shown in FIG. 19 and FIG. 20 by displaying a sequence of random matrix patterns until a sufficient number of random matrix samples enable the compressive sensing computations to recover the reflected signals using a compressive sampling algorithm. After completing the compressive sensing for the transmission beam spot in the spot position shown in 1903 and 2003, the transmission beam moves to the next beam spot position, and the compressive sensing using random matrices displayed on the SLM begins again to sample the reflections at the new beam position.

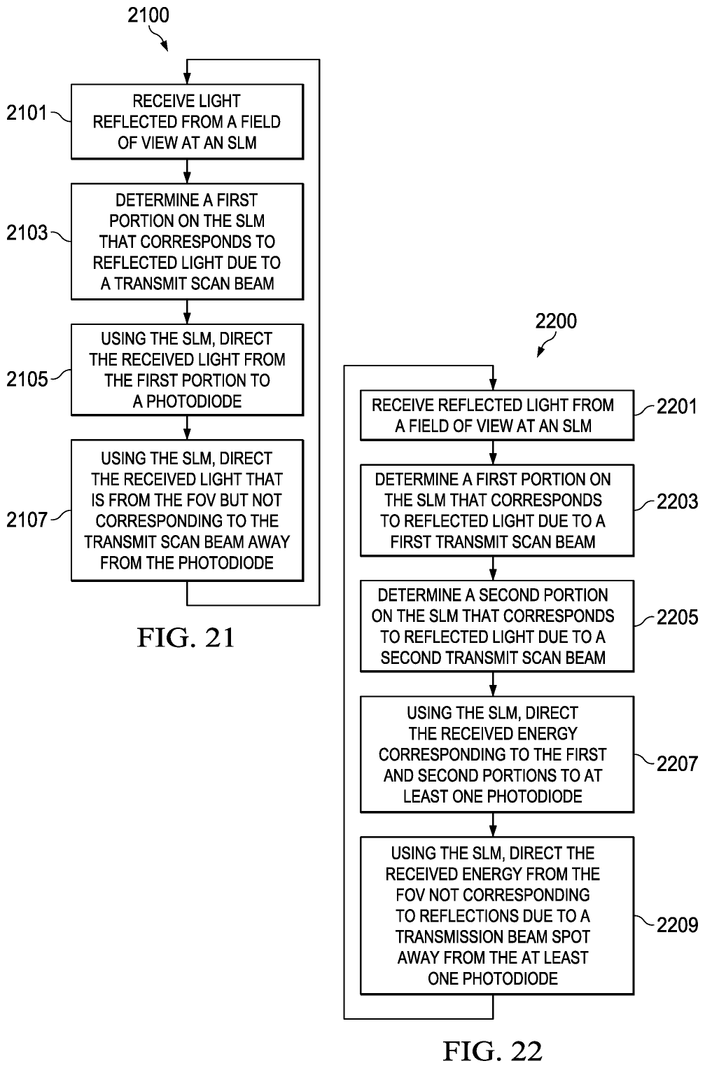

FIG. 21 is a flow diagram of a method 2100 for operating a LIDAR receiver. In FIG. 21, at a first step 2101, an SLM receives reflected energy from a FOV. At step 2103, the LIDAR receiver determines a first portion on the SLM corresponding to the reflected energy received due to the transmission beam spot. The LIDAR system both transmits the laser scan beam and receives the reflections, thus the system has the information about the current transmitter beam position. At step 2105, the SLM directs the received energy from the first portion that corresponds to reflections from the FOV due to objects illuminated by the transmission beam spot to a photodiode. As described hereinabove, the SLM displays a pattern to direct the reflections from the transmission beam spot to the photodiode. At step 2107, the SLM directs received light that is not from the first portion and that does not correspond to the reflections due to the transmission beam spot away from the photodiode. The method then continues by returning to step 2101. As described hereinabove, by rejecting reflections from other sources illuminating the FOV, these arrangements increase the SNR in the LIDAR receiver. The increase in SNR is achieved by using solid state components such as a DMD or a PSLM in the receiver, so that no motors or mechanical mirrors or rotors are needed. These arrangements are highly reliable and robust, and reasonable in cost.

FIG. 22 is a flow diagram of an alternative method for operating a LIDAR receiver. In FIG. 22, the method 2200 begins at step 2201, where reflected light is received from a FOV at an SLM. In step 2203, the LIDAR receiver determines the first portion on the SLM that receives reflected light due to a first transmit beam spot directed to the FOV. In step 2205, the LIDAR receiver determines the second portion on the SLM that corresponds to reflected light due to a second transmit beam spot directed to the FOV. In this method, the LIDAR system uses two scan beams simultaneously. In the method 2200, at step 2207, the LIDAR receiver uses the SLM to direct the received reflections from both the first portion and the second portion on the SLM to at least one photodiode. This step corresponds to the operation of FIG. 5 described hereinabove. In one arrangement where reflections from the two regions are directed to one detector, the laser beam pulses are differently modulated or encoded by the laser transmitter to allow the receiver to process the received signals and to differentiate the two scan beams. In an arrangement having two photodiodes as shown in FIG. 5, the two reflected beams are physically separated at the photodiodes and the scan beam encoding or modulation is not necessary, although in a further example, modulation could be used with two or more photodiodes to avoid interference.

At step 2209, the SLM directs the received energy that is not due to one or the other of the first and second transmission beam spots away from the photodiode or photodiodes.

The method 2200 then continues by returning to the initial step 2201.

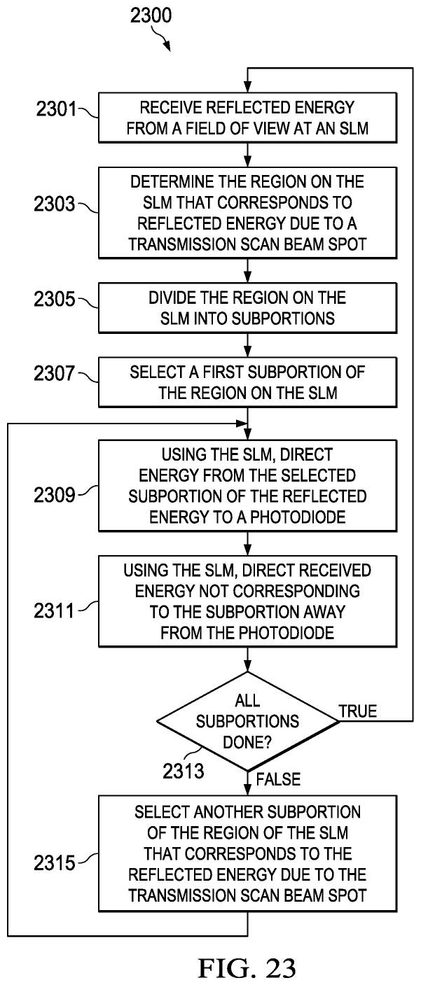

FIG. 23 is a flow diagram of yet another method for operating a LIDAR receiver. In FIG. 23, the method 2300 starts at step 2301, where an SLM receives energy reflected from a field of view. At step 2303, the region that corresponds to the reflected energy on the SLM that is due to the transmission scan beam spot illuminating an object in the FOV is determined. The LIDAR system both transmits the scan beam and receives the reflections, thus the system has the information about the position of the scan beam. In step 2305, the region of the SLM that is receiving reflected energy from the FOV due to the scan beam spot is divided into subportions. At step 2309, a loop operation begins with the SLM displaying a pattern to direct energy for the selected subportion of the region to a photodiode. At step 2311, the reflected energy received at the SLM that does not correspond to the selected subportion, including any reflected energy due to solar radiation of the objects in the FOV, is directed away from the photodiode. At step 2313, a decision step tests whether all of the subportions in the region on the SLM that corresponds to the transmission spot have been sampled. If the decision at step 2313 is false, then the method continues to step 2315, where a new subportion is selected. The method then continues by returning to step 2309 and sampling the selected subportion. The operations in FIGS. 15 and 16 (using a raster scan pattern as described hereinabove) show an example of the method.

Returning to step 2313, if all of the subportions are sampled, then the decision test is true, and the method returns to step 2300 and begins again. In this manner the receiver scans the transmission beam spot using multiple subsamples, increasing the resolution of the receiver, as described hereinabove. The LIDAR receiver updates the region of the SLM that corresponds to the current transmission spot position at step 2303.

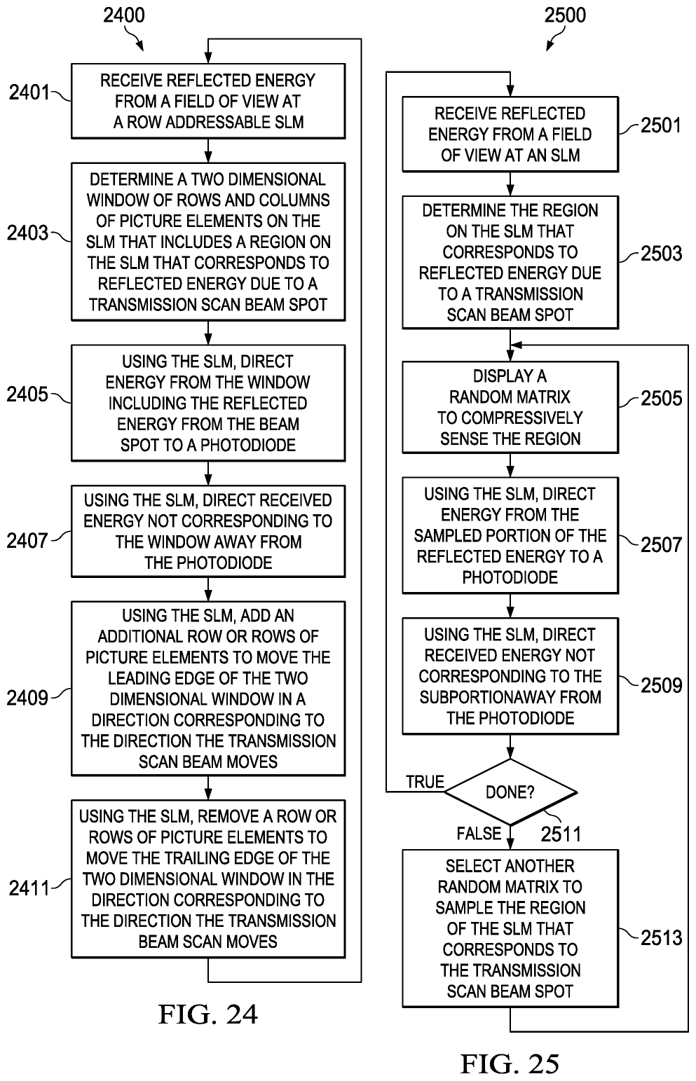

FIG. 24 is a flow diagram of another method for operating a LIDAR receiver. In FIG. 24, the method begins at step 2401, where reflected energy from a field of view is received in a row addressable SLM. In an example, the SLM is a DMD as described hereinabove. At step 2403, the LIDAR receiver determines a two-dimensional window of rows and columns of picture elements on the SLM that includes the region corresponding to reflected energy that is received from the FOV due to the transmission scan beam spot. This two-dimensional window is displayed on the SLM, such as by turning micromirrors of a DMD to the ON position to form the window, while the remaining micromirrors are turned to the OFF position.

At step 2405, the SLM directs energy received into the window to a photodiode. The two-dimensional window on the SLM includes the region that corresponds to the transmission beam spot. In an arrangement, the window can be large enough to include several positions of the transmission beam spot as it scans the field of view. At step 2407, the SLM is used to direct energy received that does not impact the two-dimensional window on the SLM away from the photodiode.

The LIDAR receiver then continues by moving the two-dimensional window. At step 2409, the two-dimensional window is moved by adding more rows to advance the leading edge row of the two-dimensional window in the direction in which the transmission scan beam moves. The LIDAR system transmits the beam into the FOV and receives the reflections from the FOV, so that system knows a then-current position of the transmission beam. The two-dimensional window on the SLM moves to track the reflected energy received due to the moving transmission scan beam.

In step 2411, the trailing edge of the two-dimensional window is adjusted to advance the two-dimensional window. These operations are shown in FIGS. 13 and 14 described hereinabove. The method then returns to step 2401 and continues. The step size for the window can vary from one row to several rows, depending on the application.

FIG. 25 is a flow diagram for a compressive sampling operation for a LIDAR receiver. At step 2501, the SLM receives reflected energy from the FOV. At step 2503, the LIDAR receiver determines the region on the SLM that corresponds to the reflected energy due to the transmission scan beam spot illuminating the FOV. At step 2505, the LIDAR receiver begins a loop and displays a random matrix selected to compressively sense the region of the SLM identified in step 2503. At step 2507, the SLM directs the received energy sampled in step 2505 to a photodiode. This operation corresponds to the operation of FIG. 19 described hereinabove. At step 2509, the LIDAR receiver uses the SLM to direct the energy that impacts the SLM outside of the region away from the photodiode. At step 2511, a decision block tests whether the compressive sensing of the region is completed. If the decision is false, the method continues to step 2513 at which another random matrix is selected to compressively sense the region on the SLM. This operation corresponds to the operation of FIG. 20 described hereinabove.

Returning to step 2511 of FIG. 25, if the decision at step 2511 is true, the compressive sensing for the region is complete, and the method continues at step 2501 for another transmission beam spot position, and the method continues.

Use of the embodiments provides LIDAR receivers with increased SNR, increased resolution, and that are compatible with compressive sensing and with subsampling techniques. In example embodiments, the LIDAR receivers have robust solid state SLMs and as few as one photodiode. The embodiments are compatible with various LIDAR transmitters including motorized laser scanners, rotating mirrors, analog MEMS mirrors, and spatial light modulators in the transmitter.

Modifications are possible in the described arrangements, and other arrangements are possible, within the scope of the claims.

What is claimed is:

1. A method, comprising:
receiving light from a field of view on a spatial light modulator that includes a two-dimensional array of picture elements in rows and columns;
determining a portion of the two-dimensional array that corresponds to a region of interest in response to a transmit scan beam illuminating the field of view;
directing light from the portion of the two-dimensional array to a photodiode; and
directing light outside the portion away from the photodiode.

2. The method of claim 1, wherein determining the portion of the two-dimensional array includes:
receiving the light onto the portion of the two-dimensional array, wherein the portion is a contiguous two-dimensional portion of the picture elements;
after receiving light onto the portion, shifting the portion to a new position; and
subsequently receiving light reflected from the field of view onto the portion at the new position.

3. The method of claim 2, wherein the spatial light modulator is one selected from: a row addressable spatial light modulator; and a column addressable spatial light modulator.

4. The method of claim 2, wherein shifting the portion to the new position includes:
writing to a row of pixel elements that is one row ahead of a leading edge of the portion of the two-dimensional array, to shift the leading edge of the portion of the two-dimensional array to the new position; and
writing to the row of pixel elements that is a current trailing edge of the portion of the two-dimensional array, to shift the trailing edge of the portion of the two-dimensional array.

5. The method of claim 4, wherein the spatial light modulator is a row addressable digital micromirror device (DMD).

6. The method of claim 1 wherein the spatial light modulator is a digital micromirror device (DMD).

7. The method of claim 1, wherein the spatial light modulator is a liquid crystal on silicon device.

8. The method of claim 1, wherein the spatial light modulator is a phase spatial light modulator.

9. The method of claim 8, wherein the phase spatial light modulator is a digital micromirror device that includes micromirrors configured to selectively displace in a direction normal to a reflective surface of the phase spatial light modulator.

10. The method of claim 1, wherein the photodiode is one selected from: a PIN photodiode; a silicon photomultiplier (SiPM); and an avalanche photodiode (APD).

11. The method of claim 1, wherein the photodiode is an avalanche photodiode (APD).

12. A method, comprising:
receiving light reflected from a field of view at a spatial light modulator that includes a two-dimensional array of picture elements;
determining a portion of the two-dimensional array that corresponds to a region of interest, in response to a transmit scan beam illuminating a part of the field of view;
dividing the portion of the two-dimensional array into subportions; and
for each subportion separately from the other subportions, directing light that impacts the two-dimensional array at the subportion to at least one photodiode, and directing light that impacts the two-dimensional array outside the subportion away from the at least one photodiode, so the light directed to the at least one photodiode over a period of time is eventually inclusive of light that impacts the two-dimensional array at the portion in response to the transmit scan beam reflected from the part of the field of view.

13. The method of claim 12, wherein the portion is a first portion, the region of interest is a first region of interest, the part of the field of view is a first part of the field of view, the subportions are first subportions, the period of time is a first period of time, and the method further comprises:
determining a second portion of the two-dimensional array that corresponds to a second region of interest, in response to the transmit scan beam illuminating a second part of the field of view; and
dividing the second portion of the two-dimensional array into second subportions; and
for each second subportion separately from the other second subportions, directing light that impacts the two-dimensional array at the second subportion to the at least one photodiode, and directing light that impacts the two-dimensional array outside the second subportion away from the at least one photodiode, so the light directed to the at least one photodiode over a second period of time is eventually inclusive of light that impacts the two-dimensional array at the second portion in response to the transmit scan beam reflected from the second part of the field of view.

14. The method of claim 12, wherein the portion is a first portion, the region of interest is a first region of interest, the transmit scan beam is a first transmit scan beam, the part of the field of view is a first part of the field of view, the subportions are first subportions, and the method further comprises:
determining a second portion of the two-dimensional array that corresponds to a second region of interest, in response to a second transmit scan beam illuminating a second part of the field of view; and
dividing the second portion of the two-dimensional array into second subportions; and
for each second subportion separately from the other second subportions, directing light that impacts the two-dimensional array at the second subportion to the at least one photodiode, and directing light that impacts the two-dimensional array outside the second subportion away from the at least one photodiode, so the light directed to the at least one photodiode over the period of time is eventually inclusive of light that impacts the two-dimensional array at the second portion in response to the second transmit scan beam reflected from the second part of the field of view.

15. The method of claim 12, wherein dividing the portion of the two-dimensional array into the subportions includes forming each subportion as a respective part of a raster scan pattern for raster scan sensing, over the period of time, of light that impacts the two-dimensional array at the portion in response to the transmit scan beam reflected from the part of the field of view.

16. The method of claim 12, wherein dividing the portion of the two-dimensional array into the subportions includes forming each subportion as a respective matrix pattern for compressive sensing, over the period of time, of light that impacts the two-dimensional array at the portion in response to the transmit scan beam reflected from the part of the field of view.

17. The method of claim 12, wherein the spatial light modulator is one selected from: a digital micromirror device; a phase spatial light modulator; and a liquid crystal on silicon spatial light modulator.

18. A method, comprising:
receiving reflected light from a field of view on a spatial light modulator;
determining a first portion of the spatial light modulator that corresponds to a first region of interest, in response to a first transmit scan beam illuminating the field of view;
determining a second portion of the spatial light modulator that corresponds to a second region of interest, in response to a second transmit scan beam illuminating the field of view;
directing light from the first portion and the second portion to at least one photodiode; and
directing light outside the first portion and outside the second portion away from the at least one photodiode.

19. The method of claim 18, wherein the at least one photodiode includes first and second photodiodes, the first photodiode receives light from the first portion, and the second photodiode receives light from the second portion.

20. The method of claim 18, wherein the light from the first transmit scan beam is modulated according to a first scheme, and the light from the second transmit scan beam is modulated according to a second scheme.

21. A system, comprising:
a LIDAR transmitter configured to scan a field of view with a laser beam using a transmit pattern; and
a LIDAR receiver configured to scan the field of view in a pattern corresponding to the transmit pattern, the LIDAR receiver including a spatial light modulator configured to: direct received light reflected from a region of interest in the field of view to a photodiode; and direct received light reflected from outside the region of interest away from the photodiode.

22. The system of claim 21, wherein the spatial light modulator is one selected from: a digital micromirror device; a liquid crystal on silicon device; and a phase spatial light modulator device.
